(19) United States
(12) Patent Application Publication
(10) Pub. No.: US 2020/0084504 A1
(43) Pub. Date: Mar. 12, 2020

(54) IMAGE TRANSMITTING APPARATUS, IMAGE RECEIVING APPARATUS, AND NON-TRANSITORY COMPUTER READABLE MEDIUM

(71) Applicant: FUJI XEROX CO.,LTD., Tokyo (JP)

(72) Inventors: Takayuki HASHIMOTO, Kanagawa (JP); Tomoyuki ONO, Kanagawa (JP); Masaki NUDEJIMA, Kanagawa (JP); Suguru OUE, Kanagawa (JP); Daiki TAKAZAWA, Kanagawa (JP); Kenji KOIZUMI, Kanagawa (JP); Atsushi UGAJIN, Kanagawa (JP); Kyoji YAGI, Kanagawa (JP); Kenichi ITO, Kanagawa (JP); Hiroki OHSAWA, Kanagawa (JP); Yukihiro SASADA, Kanagawa (JP)

(73) Assignee: FUJI XEROX CO.,LTD., Tokyo (JP)

(21) Appl. No.: 16/262,953

(22) Filed: Jan. 31, 2019

(30) Foreign Application Priority Data
Sep. 11, 2018 (JP) 2018-169882

(51) Int. Cl. H04N 21/4363; H04N 21/234; H04N 21/431; H04N 5/775

(52) U.S. Cl. CPC H04N 21/4363; H04N 5/775; H04N 21/4312; H04N 21/234

(57) ABSTRACT

An image transmitting apparatus includes a transmitting unit and a controller. The transmitting unit transmits information according to a standard for video image communication. The controller exerts control in such a manner that still image information or information other than still image information is transmitted by using a bus for video image communication. The transmitting unit transmits the still image information or the information other than still image information in accordance with the control exerted by the controller.

### CROSS-REFERENCE TO RELATED APPLICATIONS

This application is based on and claims priority under 35 USC 119 from Japanese Patent Application No. 2018-169882 filed Sep. 11, 2018.

### BACKGROUND

### (i) Technical Field

The present disclosure relates to an image transmitting apparatus, an image receiving apparatus, a non-transitory computer readable medium storing a program for image transmission, and a non-transitory computer readable medium storing a program for image reception.

### (ii) Related Art

Japanese Unexamined Patent Application Publication No. 2010-016860 discloses the following technique. An object of the technique is to provide a data transmission apparatus which achieves, in transmission of video data, a transmission form conforming to the usage of data that is to be transmitted. In the technique, data indicating the transfer mode of a transmission packet of the serial digital transfer interface (SDTI) is inserted into the payload section included in the transmission packet. Data indicating the timing mode of the transmission packet is inserted in the payload section. The transfer mode includes the synchronous transfer mode and the isochronous transfer mode as well as the asynchronous transfer mode. The timing mode defines which field in a transmission frame is to be synchronized in transfer of a transmission packet. The timing mode includes the normal mode in which the first field is used, the advanced mode in which the second field is used, and the dual mode in which both of the fields are used. Depending on settings of the timing mode, the system latency during transmission and reception may be minimized.

Japanese Unexamined Patent Application Publication No. 2015-144391 discloses the following technique. An object of the technique is to suppress disturbance of an image, which is displayed on a display panel, even when a transmission error has occurred. In the technique, a reception circuit receives, from a transmission circuit, serial data including pixel data forming image data. The serial data has a format which enables the reception circuit to detect a transmission error. A serial-parallel converter converts serial data to parallel data. An error detector determines whether or not the parallel data is correct data based on the parallel data. When the error detector determines that the parallel data is correct data, a correction buffer holds the pixel data included in the parallel data. A correction unit replaces pixel data included in the parallel data which is determined to be wrong data by the error detector, with a value corresponding to pixel data stored in the correction buffer.

Japanese Unexamined Patent Application Publication No. 2010-124157 discloses the following technique. An object of the technique is to provide an image processing apparatus, an image processing method, an image processing program, and a recording medium which optimizes fast transfer of image data from the image transmission side to the image reception side. In the technique, a digital multifunction unit causes serializers to add a START symbol and an END symbol to the top and end of line image data, and performs fast transfer to a laser diode (LD) controller. The LD controller determines whether the line image data is valid on the basis of the START symbol and the END symbol. For valid line image data, image processing is performed by using a reference number of processing lines as the reference unit of image processing. For invalid line image data, the serializers are notified of the transfer error. The serializers generate complementary line image data and transfer the generated data to the LD controller.

A standard for video image communication is used to transmit still images. For the standard, in addition to a bus through which video image information is transmitted, a bus through which communication control information is transmitted is optionally used.

However, without use of the bus through which communication control signals are transmitted, communication control information fails to be transmitted.

### SUMMARY

Aspects of non-limiting embodiments of the present disclosure relate to an image transmitting apparatus, an image receiving apparatus, a non-transitory computer readable medium storing a program for image transmission, and a non-transitory computer readable medium storing a program for image reception. In the case where a standard for video image communication is used to transmit still image information, the image transmitting apparatus, the image receiving apparatus, the non-transitory computer readable media enable information other than still image information to be transmitted without use of a bus through which communication control information is transmitted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image transmitting apparatus including a transmitting unit and a controller. The transmitting unit transmits information according to a standard for video image communication. The controller exerts control in such a manner that still image information or information other than still image information is transmitted by using a bus for video image communication. The transmitting unit transmits the still image information or the information other than still image information in accordance with the control exerted by the controller.

### BRIEF DESCRIPTION OF THE DRAWINGS

Exemplary embodiment of the present disclosure will be described in detail based on the following figures, wherein:

FIG. 1 is a conceptual diagram illustrating an exemplary module configuration according to an exemplary embodiment;

FIG. 2 is a conceptual diagram illustrating an exemplary module configuration according to the exemplary embodiment;

FIG. 3 is a diagram for describing an exemplary system configuration using the exemplary embodiment;

FIG. 4 is a flowchart of an exemplary process according to the exemplary embodiment;

FIG. 5 is a flowchart of an exemplary process according to the exemplary embodiment;

FIG. 6 is a diagram for describing an exemplary data structure of header information;

FIG. 7 is a diagram for describing exemplary commands;

FIG. 8 is a diagram for describing an exemplary data structure of register information;

FIG. 9 is a diagram for describing an exemplary data structure of register information;

FIG. 10 is a conceptual diagram illustrating an exemplary module configuration used when information for which an error has occurred is to be retransmitted, according to the exemplary embodiment;

FIG. 11 is a flowchart of an exemplary process according to the exemplary embodiment;

FIG. 12 is a flowchart of an exemplary process according to the exemplary embodiment;

FIGS. 13A and 13B are a flowchart of an exemplary process according to the exemplary embodiment;

FIGS. 14A and 14B are a flowchart of an exemplary process according to the exemplary embodiment;

FIG. 15 is a diagram for describing an exemplary process according to the exemplary embodiment;

FIG. 16 is a conceptual diagram illustrating an exemplary module configuration in a video data control module;

FIG. 17 is a diagram for describing an exemplary process according to the exemplary embodiment;

FIG. 18 is a conceptual diagram illustrating an exemplary module configuration in a video data generating module;

FIG. 19 is a conceptual diagram illustrating an exemplary module configuration in a video data control module;

FIG. 20 is a diagram for describing an exemplary process according to the exemplary embodiment; and

FIG. 21 is a block diagram illustrating an exemplary hardware configuration of a computer for implementing the exemplary embodiment.

### DETAILED DESCRIPTION

An exemplary embodiment suitable for implementing the present disclosure will be described below on the basis of the drawings.

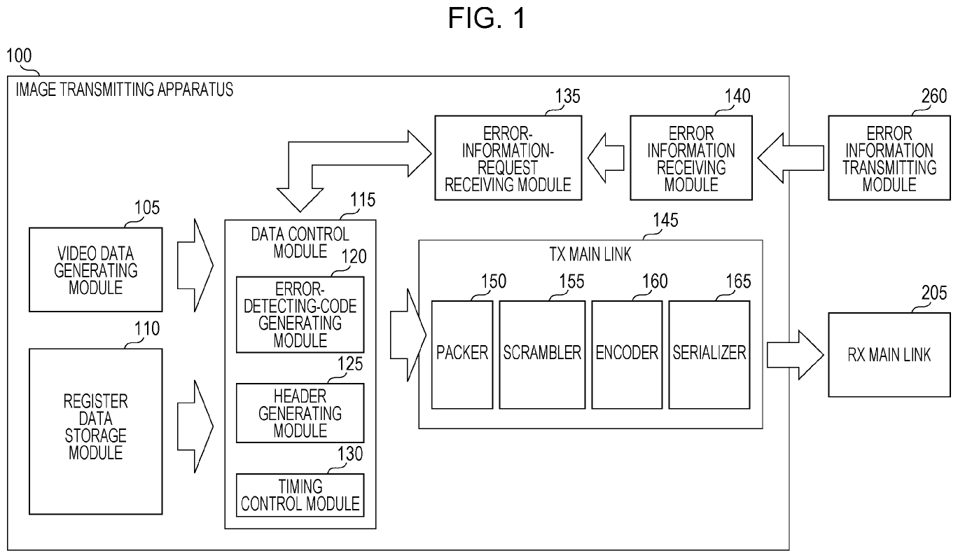

FIG. 1 is a conceptual diagram illustrating an exemplary module configuration according to the exemplary embodiment.

In general, a module refers to a component, such as software (a computer program) that is logically separable or hardware. Thus, a module in the exemplary embodiment refers to not only a module in terms of a computer program but also a module in terms of a hardware configuration. Consequently, the exemplary embodiment also describes a system, a method, and a computer program for functioning as a module (a program that causes a computer to execute procedures, a program that causes a computer to function as units, or a program that causes a computer to implement functions). For convenience of explanation, the terms “to store something” and “to cause something to store something”, and their equivalent terms are used. When the exemplary embodiment is implemented by using computer programs, these terms mean that a storage device stores something or that a storage device is controlled so as to store something. One module may correspond to one function. However, in the implementation, one program may constitute one module, or one program may constitute multiple modules. In contrast, multiple programs may constitute a single module. Additionally, multiple modules may be executed by a single computer, or one module may be executed by multiple computers in a distributed or parallel processing environment. One module may include another module. Hereinafter, the term “connect” refers to logical connection, such as transmission/reception of data, an instruction, reference relationship between pieces of data, or login, as well as physical connection. The term “predetermined” refers to a state in which determination has been made before a target process. This term also includes a meaning in which determination has been made in accordance with the situation or state at that time or the situation or state before that time, not only before processes according to the exemplary embodiment start, but also before the target process starts even after the processes according to the exemplary embodiment have started. When multiple “predetermined values” are present, these may be different from one another, or two or more of the values (including all values, of course) may be the same. A description of “when A is satisfied, B is performed” is used as having a meaning of “whether or not A is satisfied is determined and, when it is determined that A is satisfied, B is performed”. However, this term does not include a case where the determination as to whether or not A is satisfied is unnecessary. In addition, the case in which things are listed, such as “A, B, and C”, indicates exemplary listing unless otherwise noted, and includes the case in which only one member is selected (for example, only A).

A system or apparatus refers to one in which multiple computers, pieces of hardware, devices, and the like are connected to one another by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) operating on man-made agreements.

For each of the processes performed by the respective modules, or for each of the processes if the processes are performed in a single module, target information is read out from a storage device. After the process is performed, the processing result is written in a storage device. Accordingly, description about the reading of data from the storage device before the process and the writing into the storage device after the process may be skipped. Examples of the storage device may include a hard disk drive, a random access memory (RAM), an external storage medium, a storage apparatus via a communication line, and a register in a central processing unit (CPU).

An image transmitting apparatus 100 according to the exemplary embodiment transmits (through serial communication) information such as still images to an image receiving apparatus 200 according to a standard for video image communication. As illustrated in the example in FIG. 1, the image transmitting apparatus 100 includes a video data generating module 105, a register data storage module 110, a data control module 115, an error-information-request receiving module 135, an error information receiving module 140, and a Tx main link 145.

Examples of a “standard for video image communication” include V-by-One HS which is a serial interface and which may be controlled by using a pair of differential signal lines. “Standards” include standards defined by public institutions, such as Japanese Industrial Standards (JIS), as well as standards which are social general standards (industry standards), and may also include de facto standards which are used as standards in fact. Herein, the Tx main link 145 on the transmission side and an Rx main link 205 on the reception side are illustrated as communication modules according to V-by-One HS.

In the exemplary embodiment, in addition to transmission of still image information from the image transmitting apparatus 100 to the image receiving apparatus 200, particularly, writing to registers 265 in the image receiving apparatus 200 from the image transmitting apparatus 100 is performed through transfer based on the V-by-One HS standard used in video data transmission.

The V-by-One HS standard optionally enables transfer control during video data transmission (while DE is asserted) and transfer control (of CTL signals) when video data is not transmitted. Therefore, transfer for register access may be performed by using CTL signals. Specifically, while DE (data enable signal) is de-asserted, CTL signals are used to perform transfer for register access.

However, it is desirable to perform writing to registers in the same transfer as video data transmission, without use of the option using CTL signals for reduction in the circuit size (which indicates that no CTL signals are implemented and the number of pins is decreased).

Accordingly, the image transmitting apparatus 100 transmits a code indicating whether transmission data is video data (still image information) or register information (an example of “information for determining whether transmission data is register information or still image information”).

In addition, in the V-by-One HS standard, one-way transfer from the image transmitting apparatus 100 on the transmission side is performed. Therefore, in video data transmission using the V-by-One HS standard as it is, a process performed when register access (transfer of register information) fails is not capable of being performed.

Accordingly, the image transmitting apparatus 100 and the image receiving apparatus 200 perform a process for the case in which register access fails.

The video data generating module 105 is connected to the data control module 115. The video data generating module 105 generates still image information, and transmits the still image information to the data control module 115. For example, this corresponds to reading an image with a data reading apparatus such as a scanner. Other than this, this encompasses, for example, taking a photograph with a camera, receiving an image from external equipment through communication connection by using a fax or the like, taking a video with a charge-coupled device (CCD) or the like, and reading an image stored in a hard disk or the like (in addition to a hard disk included in a computer, including, for example, a hard disk connected over a network). An image may be a binary image or a multivalued image (including a color image). One or more images may be received.

The register data storage module 110 is connected to the data control module 115. The register data storage module 110 stores register information which is to be set in the registers 265 of the image receiving apparatus 200 which is the transmission destination. The register data storage module 110 transmits the register information to the data control module 115 conforming to transmission of still image information (typically, prior to transmission of still image information).

The data control module 115, which includes an error-detecting-code generating module 120, a header generating module 125, and a timing control module 130, is connected to the video data generating module 105, the register data storage module 110, the error-information-request receiving module 135, and the Tx main link 145. The data control module 115 uses a bus for video image communication to exert control so that still image information or information other than still image information is transmitted. That is, the data control module 115 determines whether data from the video data generating module 105 or data from the register data storage module 110 is used in data transfer.

As “information other than still image information”, for example, register information to be stored in registers of the image receiving apparatus 200 which is the transmission destination may be used.

The error-detecting-code generating module 120 generates a code for error detection for information that is to be transmitted. As a matter of course, “information to be transmitted” is still image information or information other than still image information. A code for error detection for still image information may be generated or a code for error detection for information other than still image information may be generated. Alternatively, both may be generated. As a code for error detection, for example, cyclic redundancy check (CRC) may be used. Alternatively, another error detecting code (such as a parity code or a Hamming code) may be used.

The data control module 115 exerts control so that a code generated by the error-detecting-code generating module 120 is transmitted.

When the data control module 115 receives, from the transmission destination, information indicating that an error has occurred in register information, the data control module 115 may exert control so that at least register information for which an error has occurred is transmitted to the transmission destination.

When an error has occurred in register information, the data control module 115 may retransmit the register information. When an error has occurred in still image information, the data control module 115 may not retransmit the still image information.

When the data control module 115 receives, from the transmission destination, information indicating that an error is present, the data control module 115 may exert control in one of the following methods: a method in which the data control module 115 transmits, to the transmission destination, only the register information for which an error has occurred; and a method in which the data control module 115 transmits, to the transmission destination, register information which has been already transmitted and which includes the register information for which an error has occurred.

“Register information which has been already transmitted and which includes the register information for which an error has occurred” may indicate, for example, “register information including register information, for which an error has occurred, at the top and its subsequent register information”. In this case, register information for which no error has occurred is transmitted in some cases.

When register information is to be transmitted, the header generating module 125 generates header information (A) indicating that information to be transmitted is register information. When still image information is to be transmitted, the header generating module 125 generates header information (B) indicating that information to be transmitted is still image information.

When register information is to be transmitted, the data control module 115 exerts control so that header information (A) generated by the header generating module 125 is transmitted. When still image information is to be transmitted, the data control module 115 exerts control so that header information (B) generated by the header generating module 125 is transmitted.

The timing control module 130 controls the timing at which the Tx main link 145 transmits information (still image information or information other than still image information) to the Rx main link 205. Specifically, the timing control module 130 controls the timing at which a vertical synchronizing signal (VSYNC) and a horizontal synchronizing signal (HSYNC), which are timing control signals, and DE, which is a data enable signal, are transmitted.

The error information receiving module 140 is connected to the error-information-request receiving module 135 and an error information transmitting module 260. The error information receiving module 140 receives, from the error information transmitting module 260 of the image receiving apparatus 200, information indicating that received information (information having been transmitted by the Tx main link 145, especially, register information) has an error. Examples of information received by the error information receiving module 140 include the address of a register for which an error has occurred.

The error-information-request receiving module 135 is connected to the data control module 115 and the error information receiving module 140. According to error information received from the image receiving apparatus 200, the error-information-request receiving module 135 extracts, from the register data storage module 110, information that is to be retransmitted (especially, register information), and instructs the data control module 115 to retransmit the information. After transmission of register information, the error-information-request receiving module 135 may ask the image receiving apparatus 200 about whether or not the transmitted register information has an error. Error information for register information includes the register number of register information having an error.

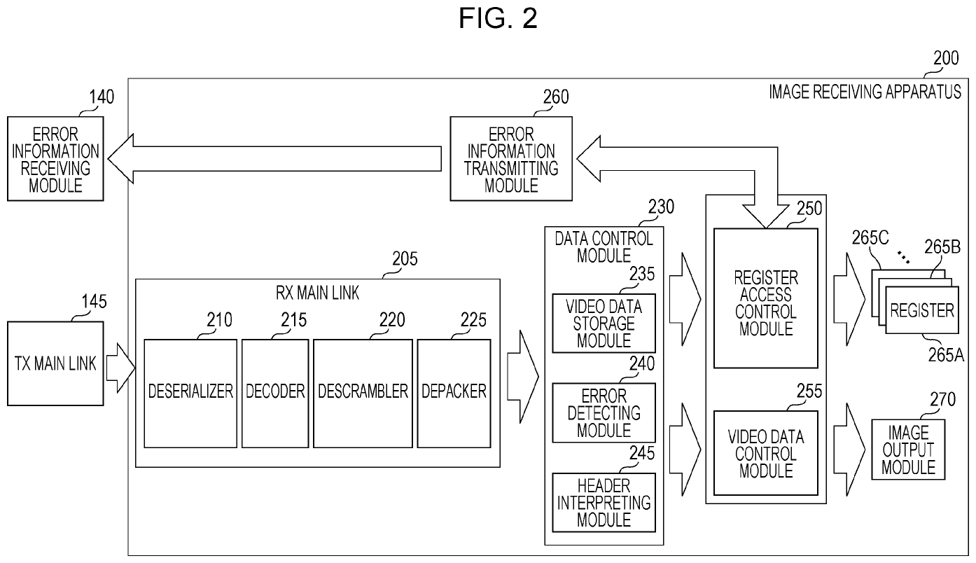

The Tx main link 145, which includes a packer 150, a scrambler 155, an encoder 160, and a serializer 165, is connected to the data control module 115 and the Rx main link 205. The Tx main link 145 transmits information to the Rx main link 205 of the image receiving apparatus 200 illustrated in the example in FIG. 2, according to the standard for video image communication (especially, the V-by-One HS standard).

The Tx main link 145 transmits still image information or information other than still image information according to the control exerted by the data control module 115.

The Tx main link 145 may transmit information for determining whether transmission data is register information or still image information. For example, header information may include information for determining whether transmission data is register information or still image information.

The packer 150, the scrambler 155, the encoder 160, and the serializer 165 perform transmission according to the V-by-One HS standard.

The Rx main link 205 of the image receiving apparatus 200 connected to the Tx main link 145 of the image transmitting apparatus 100 receives information transmitted from the Tx main link 145.

The error information transmitting module 260 of the image receiving apparatus 200 is connected to the error information receiving module 140 of the image transmitting apparatus 100. When information (especially, register information) transmitted from the Tx main link 145 has an error, the error information transmitting module 260 transmits, to the error information receiving module 140, information indicating the presence of an error.

FIG. 2 is a conceptual diagram illustrating an exemplary module configuration according to the exemplary embodiment.

The image receiving apparatus 200 includes the Rx main link 205, a data control module 230, a register access control module 250, a video data control module 255, the error information transmitting module 260, the registers 265 (such as a register 265A, a register 265B, and a register 265C), and an image output module 270. The image receiving apparatus 200 receives (through serial communication) information such as a still image from the image transmitting apparatus 100 according to the standard for video image communication.

The Rx main link 205, which includes a deserializer 210, a decoder 215, a descrambler 220, and a depacker 225, is connected to the Tx main link 145 and the data control module 230. The Rx main link 205 receives information from the Tx main link 145 of the image transmitting apparatus 100 illustrated in the example in FIG. 1, according to the standard for video image communication (especially, the V-by-One HS standard).

Information received by the Rx main link 205 is still image information or information other than still image information. Information for determining whether the transmission data is register information or still image information is added to the received information. For example, the header information may include information for determining whether transmission data is register information or still image information.

The deserializer 210, the decoder 215, the descrambler 220, and the depacker 225 perform a reception process according to the V-by-One HS standard.

The Tx main link 145 of the image transmitting apparatus 100 connected to the Rx main link 205 transmits information to the Rx main link 205.

The error information receiving module 140 of the image transmitting apparatus 100 is connected to the error information transmitting module 260. When information (especially register information) received by the Rx main link 205 has an error, the error information receiving module 140 receives, from the error information transmitting module 260, information indicating the presence of an error.

The data control module 230 includes a video data storage module 235, an error detecting module 240, and a header interpreting module 245. The data control module 230 is connected to the Rx main link 205, the register access control module 250, and the video data control module 255. The data control module 230 determines whether information received by the Rx main link 205 is still image information or information other than still image information, and further determines whether or not the information received by the Rx main link 205 has an error.

The video data storage module 235 stores still image information received by the Rx main link 205.

The error detecting module 240 uses the code for error detection in information received by the Rx main link 205, so as to perform error detection on the information (still image information or information other than still image information). When the register information has an error, the error detecting module 240 informs the register access control module 250 of the result (the register information (register number) having an error). When still image information has an error, the error detecting module 240 informs the video data control module 255 of the result (the area in which an error is present).

The header interpreting module 245 determines whether information received by the Rx main link 205 is still image information or information other than still image information. For example, when the header information in information received by the Rx main link 205 includes information indicating that the received information is still image information, the header interpreting module 245 determines that the received information is still image information. When the header information includes information indicating that the received information is register information, the header interpreting module 245 determines that the received information is register information.

The register access control module 250 is connected to the data control module 230, the error information transmitting module 260, and the registers 265 (such as the register 265A, the register 265B, and the register 265C). The register access control module 250 receives register information received by the Rx main link 205, and sets the register information to the corresponding one(s) of the registers 265. When the error detecting module 240 finds that the received register information has an error, the register access control module 250 transmits, to the error information transmitting module 260, the register number of the register information having an error.

The video data control module 255 is connected to the data control module 230 and the image output module 270. The video data control module 255 transmits, to the image output module 270, still image information received by the Rx main link 205.

When an error is detected in still image information received by the Rx main link 205 (when the error detecting module 240 finds that an error is present), the video data control module 255 changes the error information to information indicating that the still image information has an error.

Alternatively, the video data control module 255 may change the portion, in which an error is present, of the still image information so that the portion is made inconspicuous or is emphasized.

As a change operation for making the portion inconspicuous, the video data control module 255 may replace the portion, in which an error is present, of the still image information with the data in the previous area.

As a change operation for emphasizing the portion, the video data control module 255 may replace the portion, in which an error is present, of the still image information with image information of a predetermined color, or may embed information, which indicates that an error is present, in the received still image information. Examples of “a predetermined color” include black and white. As “information indicating that an error is present”, for example, digital watermark information may be used.

The video data control module 255 may make the change method different depending on the attribute of still image information received by the Rx main link 205.

For example, when the attribute indicates a photograph area, the video data control module 255 may replace the portion, in which an error is present, of the still image information with the data of the previous area.

For example, when the attribute indicates a figure area, the video data control module 255 may replace the portion, in which an error is present, of the still image information with data indicating a blank.

For example, when the attribute indicates a character area, the video data control module 255 may use the portion, in which an error is present, of the still image information as it is. The expression, “use a portion, in which an error is present, of still image information as it is”, indicates that the change operation is not performed.

The error information transmitting module 260 is connected to the register access control module 250 and the error information receiving module 140 of the image transmitting apparatus 100. When information (especially, register information) received by the Rx main link 205 has an error, the error information transmitting module 260 transmits, to the error information receiving module 140, information indicating the presence of an error. When a request for error information has been received, the error information transmitting module 260 may transmit error information.

The registers 265 (such as the register 265A, the register 265B, and the register 265C) are connected to the register access control module 250. The register access control module 250 sets register information transmitted from the image transmitting apparatus 100, to the corresponding one(s) of the registers 265. For example, information (for example, the vertical pixel count and the horizontal pixel count of still image information) used when the image output module 270 outputs still image information is set to these registers 265.

The image output module 270 is connected to the video data control module 255. The image output module 270 outputs still image information received from the video data control module 255. For example, this corresponds to an operation of printing an image by using a print apparatus such as a printer. Other than this, this encompasses, for example, a displaying operation on a display apparatus such as a display, a transmission operation of transmitting an image to an image transmitting apparatus such as a fax, a writing operation of writing an image to an image storage device such as an image database, a storage operation on a storage medium such as a memory card, and a transmission operation of transmitting information to another information processing apparatus.

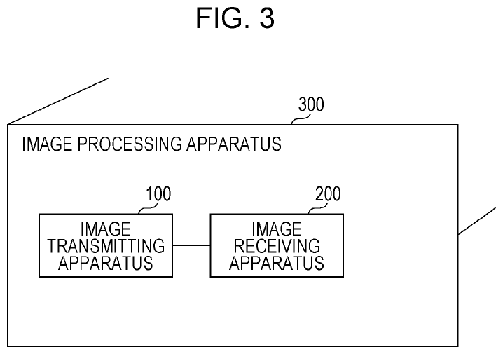

FIG. 3 is a diagram for describing an exemplary system configuration using the exemplary embodiment.

An image processing apparatus 300 includes the image transmitting apparatus 100 and the image receiving apparatus 200. The image transmitting apparatus 100 is connected to the image receiving apparatus 200. The image transmitting apparatus 100 transmits, to the image receiving apparatus 200, still image information obtained from a scanner or the like, for example, according to the V-by-One HS standard. The image receiving apparatus 200 receives the still image information and prints the image by using a printer.

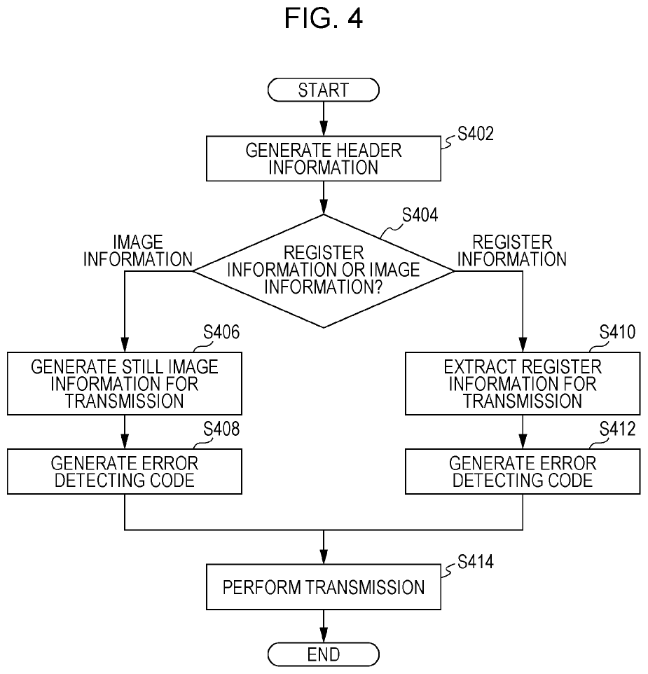

FIG. 4 is a flowchart of an exemplary process according to the exemplary embodiment (in the image transmitting apparatus 100).

In step S402, the header generating module 125 generates header information.

In step S404, it is determined whether or not the information to be transmitted is register information or image information. If the information is register information, the process proceeds to step S410. If the information is image information, the process proceeds to step S406.

In step S406, the data control module 115 (video data generating module 105) generates still image information that is to be transmitted.

In step S408, the error-detecting-code generating module 120 generates an error detecting code.

In step S410, the data control module 115 extracts, from the register data storage module 110, register information that is to be transmitted.

In step S412, the error-detecting-code generating module 120 generates an error detecting code.

In step S414, the Tx main link 145 performs a transmission process.

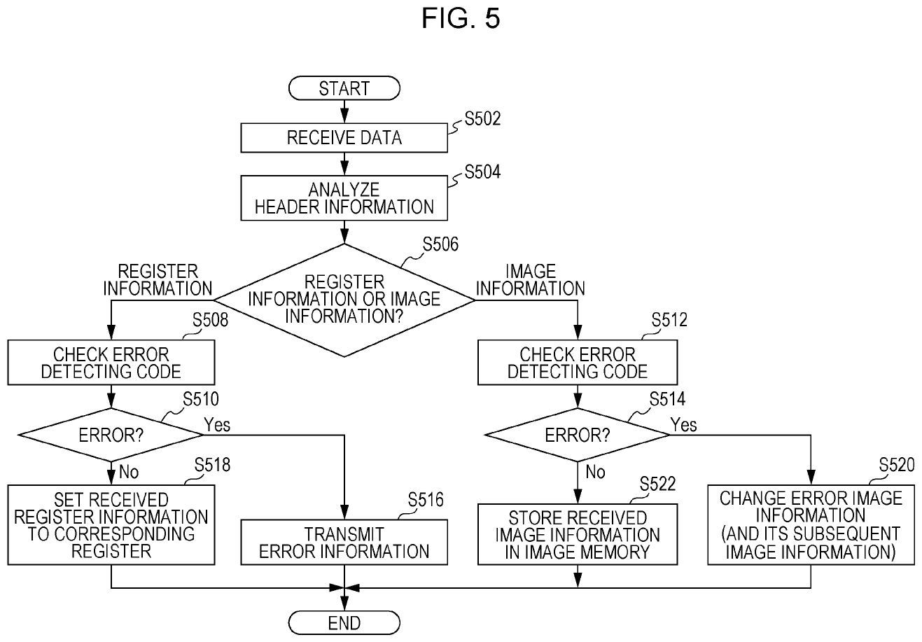

FIG. 5 is a flowchart of an exemplary process according to the exemplary embodiment (in the image receiving apparatus 200).

In step S502, the Rx main link 205 receives data.

In step S504, the header interpreting module 245 analyzes the header information.

In step S506, it is determined whether the data is register information or image information. If the data is register information, the process proceeds to step S508. If the data is image information, the process proceeds to step S512.

In step S508, the error detecting module 240 checks the error detecting code.

In step S510, the error detecting module 240 determines whether or not an error is present. If an error is present, the process proceeds to step S516. Otherwise, the process proceeds to step S518.

In step S512, the error detecting module 240 checks the error detecting code.

In step S514, the error detecting module 240 determines whether or not an error is present. If an error is present, the process proceeds to step S520. Otherwise, the process proceeds to step S522.

In step S516, the error information transmitting module 260 transmits error information.

In step S518, the register access control module 250 sets the received register information to the corresponding one(s) of the registers 265.

In step S520, the video data control module 255 changes the image information having an error (and its subsequent image information).

In step S522, the data control module 230 stores the received image information in an image memory (the video data storage module 235).

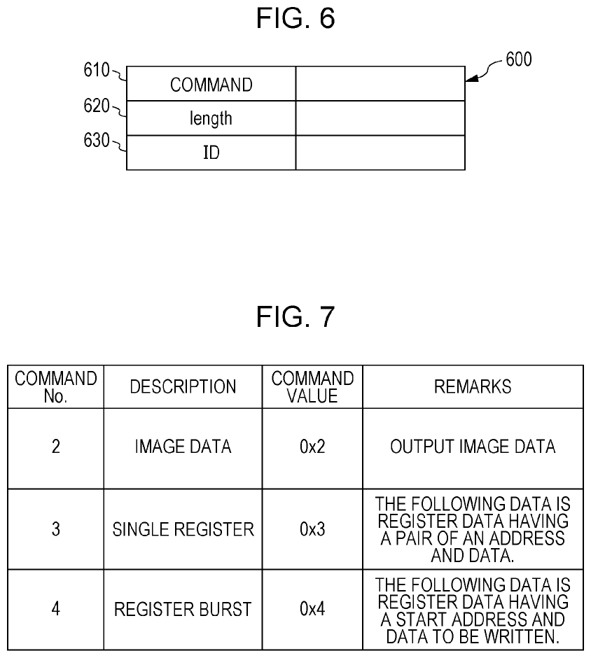

FIG. 6 is a diagram for describing an exemplary data structure of header information 600. The header information 600 is generated by the header generating module 125 (step S402), and is interpreted by the header interpreting module 245 (step S504).

The header information 600 has the command field 610, the length field 620, and the ID field 630. The command field 610 stores a command indicating the type of transmission data. The length field 620 stores the data transmission amount. The ID field 630 stores information (identification(ID)) for uniquely identifying the transmission data in the exemplary embodiment.

The header information 600 is the first data after DE (data enable signal) is asserted, in input to the packer 150 of the Tx main link 145.

The image receiving apparatus 200 interprets the header information 600, and determines whether the data is still image information (video data) or register information. To determine whether or not data transmission has been correctly performed, a code for error detection is added at the end of the transmission data.

FIG. 7 is a diagram for describing exemplary commands described in the command field 610 of the header information 600.

In “command No. 2”, the description describes “image data”, and the command value is “0x2”, which means “output image data”.

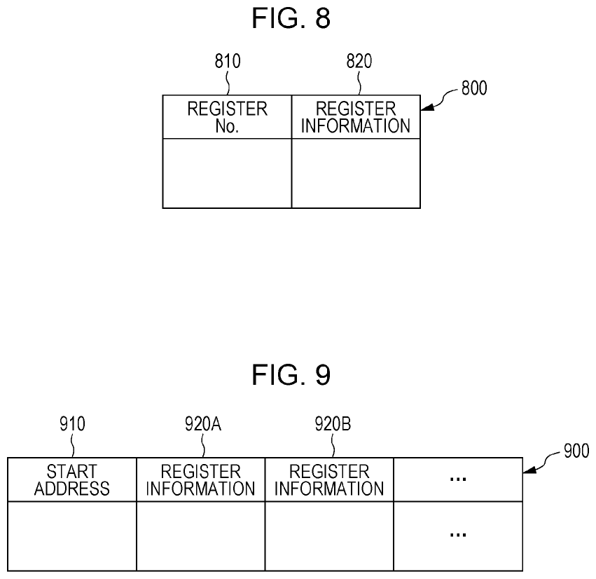

In “command No. 3”, the description describes “single register”, and the command value is “0x3”, which means “The following data is register data having a pair of an address and data”. For example, a register information structure 800 follows the command. FIG. 8 is a diagram for describing an exemplary data structure of the register information structure 800. The register information structure 800 has the register No. field 810 and the register information field 820. The register No. field 810 stores a register number. The register information field 820 stores register information that is to be set to the register corresponding to the register number.

In “command No. 4”, the description describes “register burst”, and the command value is “0x4”, which means “The following data is register data having a start address and data to be written”. For example, a register information structure 900 follows the command. FIG. 9 is a diagram for describing an exemplary data structure of the register information structure 900. The register information structure 900 has the start address field 910, the register information field 920A, and the register information field 920B. The start address field 910 stores the start address of the registers. The register information field 920A, the register information field 920B, and the like store register information that is to be set to registers starting at the start address.

In addition, for example, transmission of pattern data which is test data may be included.

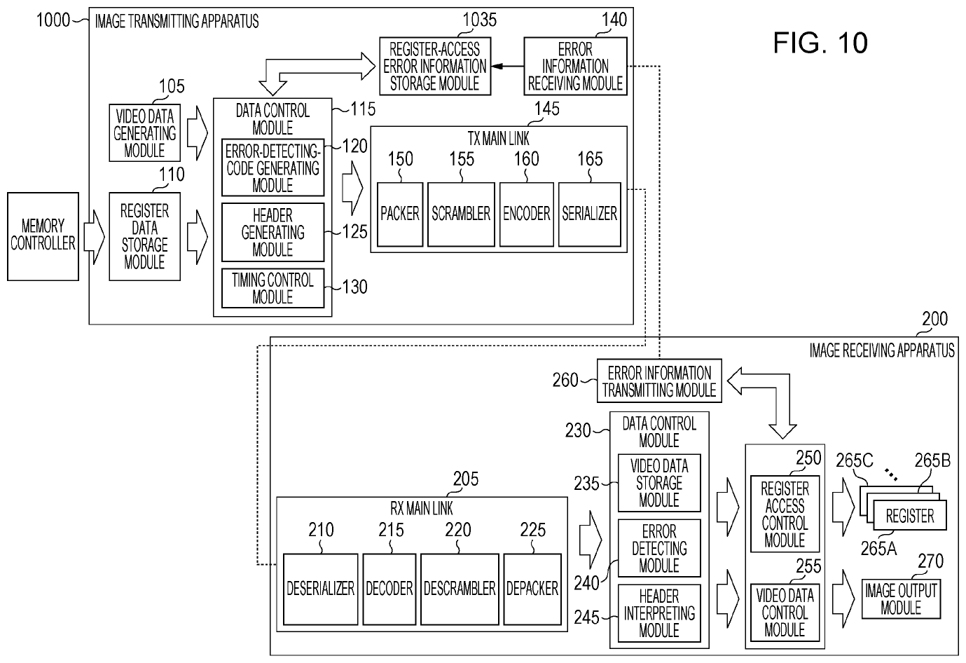

FIG. 10 is a conceptual diagram illustrating a module configuration according to the exemplary embodiment, which is used when information for which an error has occurred is retransmitted. Particularly, when multiple pieces of register information are continuously transmitted, a register-access error information storage module 1035 stores received error information.

An image transmitting apparatus 1000 includes the video data generating module 105, the register data storage module 110, the data control module 115, the register-access error information storage module 1035, the error information receiving module 140, and the Tx main link 145.

The register-access error information storage module 1035 is connected to the data control module 115 and the error information receiving module 140.

V-by-One HS is based on one-way transmission from the transmission side. As a process performed when register access (transfer) fails, the following processes are performed.

The image transmitting apparatus 1000 continuously transmits register information like chained directly memory access (DMA). In transmission of register information, a code for error detection is added, and the image receiving apparatus 200 performs error detection. When the image receiving apparatus 200 detects an error (particularly a transfer error), the error information transmitting module 260 transmits error information to the image transmitting apparatus 1000 at once (transmits error information without waiting a request to transmit error information, from the image transmitting apparatus 1000), and the register-access error information storage module 1035 stores the error information. The error information includes the register number of a register for which an error has occurred. According to the stored error information, the register-access error information storage module 1035 instructs the data control module 115 to retransmit the register information.

In transmission of register information, the data control module 115 accesses the register data storage module 110 to obtain the register information.

At that time, like chained DMA, data is obtained and the register information is transmitted multiple times.

The image receiving apparatus 200 performs retransmission, when appropriate, by returning, to the image transmitting apparatus 100, the register number for which an error has occurred.

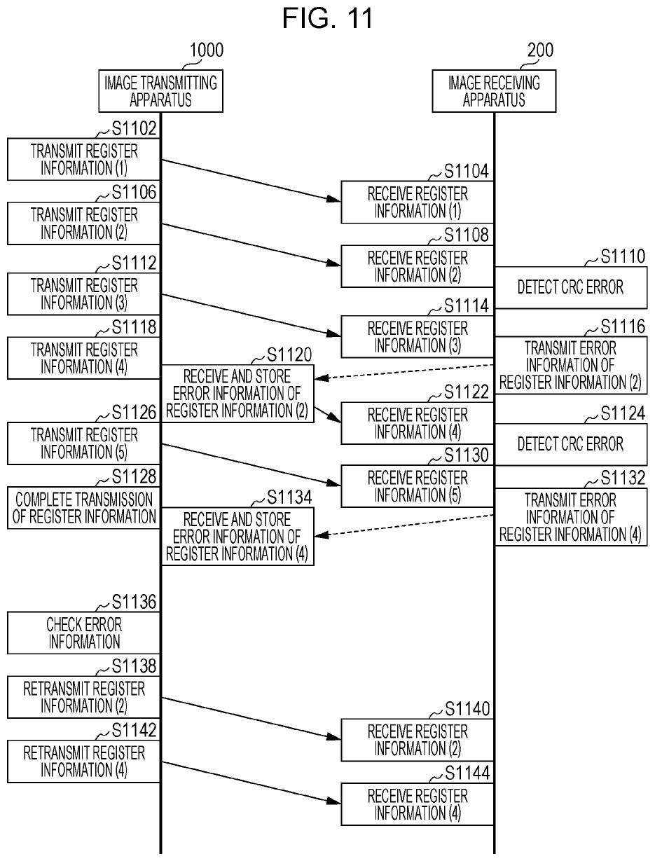

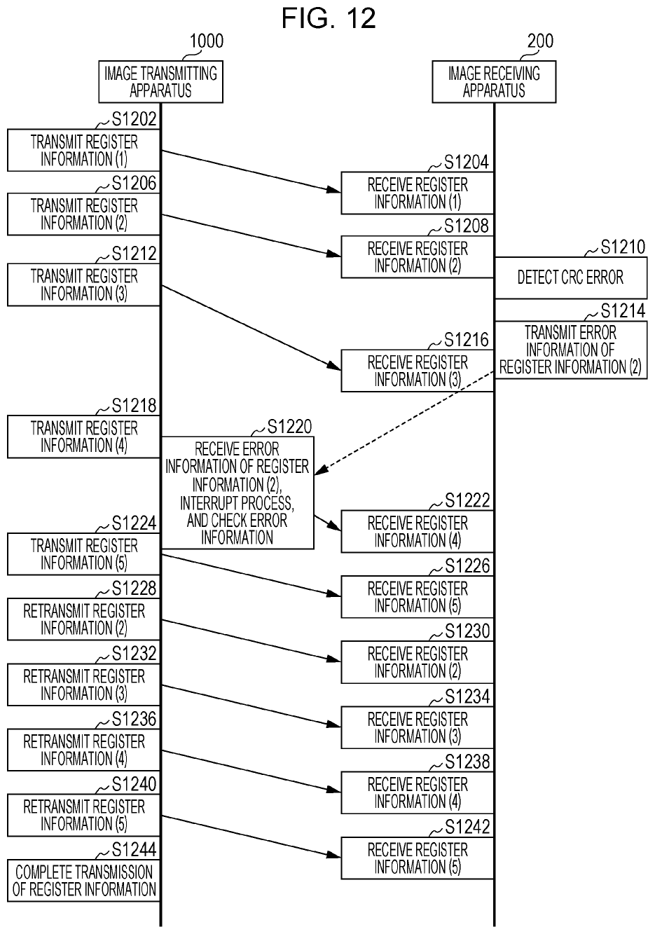

FIGS. 11 and 12 illustrate exemplary sequences of retransmission.

FIG. 11 is a flowchart of an exemplary process according to the exemplary embodiment. After transmission of all of the register information, only register information for which an error has occurred is retransmitted.

In step S1102, the image transmitting apparatus 1000 transmits register information (1) to the image receiving apparatus 200.

In step S1104, the image receiving apparatus 200 receives register information (1) from the image transmitting apparatus 1000.

In step S1106, the image transmitting apparatus 1000 transmits register information (2) to the image receiving apparatus 200.

In step S1108, the image receiving apparatus 200 receives register information (2) from the image transmitting apparatus 1000.

In step S1110, the image receiving apparatus 200 detects a CRC error (an example indicating that register information has an error).

In step S1112, the image transmitting apparatus 1000 transmits register information (3) to the image receiving apparatus 200.

In step S1114, the image receiving apparatus 200 receives register information (3) from the image transmitting apparatus 1000.

In step S1116, the image receiving apparatus 200 transmits error information for register information (2) to the image transmitting apparatus 1000.

In step S1118, the image transmitting apparatus 1000 transmits register information (4) to the image receiving apparatus 200.

In step S1120, the image transmitting apparatus 1000 receives the error information for register information (2) from the image receiving apparatus 200, and stores the data.

In step S1122, the image receiving apparatus 200 receives register information (4) from the image transmitting apparatus 1000.

In step S1124, the image receiving apparatus 200 detects a CRC error (an example indicating that register information has an error).

In step S1126, the image transmitting apparatus 1000 transmits register information (5) to the image receiving apparatus 200.

In step S1128, the image transmitting apparatus 1000 completes transmission of the register information.

In step S1130, the image receiving apparatus 200 receives register information (5) from the image transmitting apparatus 1000.

In step S1132, the image receiving apparatus 200 transmits error information for register information (4) to the image transmitting apparatus 1000.

In step S1134, the image transmitting apparatus 1000 receives the error information for register information (4) from the image receiving apparatus 200, and stores the data.

In step S1136, the image transmitting apparatus 1000 checks the error information.

In step S1138, the image transmitting apparatus 1000 retransmits register information (2) to the image receiving apparatus 200.

In step S1140, the image receiving apparatus 200 receives register information (2) from the image transmitting apparatus 1000.

In step S1142, the image transmitting apparatus 1000 retransmits register information (4) to the image receiving apparatus 200.

In step S1144, the image receiving apparatus 200 receives register information (4) from the image transmitting apparatus 1000.

The image transmitting apparatus 1000 performs steps S1102, S1106, S1112, S1118, S1126, and S1128 sequentially. The processes in steps S1120 and S1134 are performed in response to the processes in steps S1116 and S1132 performed by the image receiving apparatus 200.

Therefore, as illustrated in the example in FIG. 11, execution of step S1120 is not limited to execution after step S1118, and execution of step S1034 is not limited to execution after step S1128. Step S1120 may be performed at least after step S1106 and after step S1116.

Step S1134 may be performed at least after step S1118 and after step S1132.

FIG. 12 is a flowchart of an exemplary process according to the exemplary embodiment. Every time an error occurs, its subsequent register information is retransmitted. That is, in response to reception of error information, the image transmitting apparatus 1000 interrupts the process, and starts retransmission at that time point. The image transmitting apparatus 1000 retransmits register information including register information for which no error has occurred. Register information may be retransmitted starting from the first register information or from the register information for which an error has occurred. The example in FIG. 12 illustrates the latter case (retransmission of register information starting from the register information for which an error has occurred).

In step S1202, the image transmitting apparatus 1000 transmits register information (1) to the image receiving apparatus 200.

In step S1204, the image receiving apparatus 200 receives register information (1) from the image transmitting apparatus 1000.

In step S1206, the image transmitting apparatus 1000 transmits register information (2) to the image receiving apparatus 200.

In step S1208, the image receiving apparatus 200 receives register information (2) from the image transmitting apparatus 1000.

In step S1210, the image receiving apparatus 200 detects a CRC error (an example indicating that register information has an error).

In step S1212, the image transmitting apparatus 1000 transmits register information (3) to the image receiving apparatus 200.

In step S1214, the image receiving apparatus 200 transmits error information for register information (2) to the image transmitting apparatus 1000.

In step S1216, the image receiving apparatus 200 receives register information (3) from the image transmitting apparatus 1000.

In step S1218, the image transmitting apparatus 1000 transmits register information (4) to the image receiving apparatus 200.

In step S1220, the image transmitting apparatus 1000 receives the error information for register information (2) from the image receiving apparatus 200, and the process is interrupted. The image transmitting apparatus 1000 checks the error information. At that time point, the image transmitting apparatus 1000 has started step S1224.

In step S1222, the image receiving apparatus 200 receives register information (4) from the image transmitting apparatus 1000.

In step S1224, the image transmitting apparatus 1000 transmits register information (5) to the image receiving apparatus 200.

In step S1226, the image receiving apparatus 200 receives register information (5) from the image transmitting apparatus 1000.

In step S1228, the image transmitting apparatus 1000 retransmits register information (2) to the image receiving apparatus 200.

In step S1230, the image receiving apparatus 200 receives register information (2) from the image transmitting apparatus 1000.

In step S1232, the image transmitting apparatus 1000 retransmits register information (3) to the image receiving apparatus 200.

In step S1234, the image receiving apparatus 200 receives register information (3) from the image transmitting apparatus 1000.

In step S1236, the image transmitting apparatus 1000 retransmits register information (4) to the image receiving apparatus 200.

In step S1238, the image receiving apparatus 200 receives register information (4) from the image transmitting apparatus 1000.

In step S1240, the image transmitting apparatus 1000 retransmits register information (5) to the image receiving apparatus 200.

In step S1242, the image receiving apparatus 200 receives register information (5) from the image transmitting apparatus 1000.

In step S1244, the image transmitting apparatus 1000 completes transmission of the register information.

The V-by-One HS standard is suitable for video (moving image) transmission. Even when data destroyed due to noise causes the display to be disturbed, the moving image itself does not receive a great influence (because the disturbance occurs, for example, on a pixel-by-pixel (dot-by-dot) basis, a scanning-line-by-scanning-line (line-by-line) basis, or a frame-by-frame basis). For example, in the case of 60 fps (frame per second, frame rate), since switching to the next frame is performed every 17 ms, influence from noise is small. The noise corresponds to transmission error.

However, in the case of use of the image receiving apparatus 200, since the transmission target is a still image, data destroyed due to noise is printed as it is, causing the quality to be adversely affected.

Therefore, the image transmitting apparatus 100 and the image receiving apparatus 200 are capable of determining whether or not still image information having been transmitted is correct.

Specifically, as a code for error detection is generated for register information as described above, a code for error detection is generated also for still image information.

In input to the packer 150 of the Tx main link 145, the header information 600 is used as the first data transmitted after DE (data enable signal) is asserted. A code for error detection is added at the end of transmission data. For example, the end of transmission data may indicate the end of each line, the end of each set of a predetermined number of lines, or the end of each set of a predetermined number of pixels.

The image receiving apparatus 200 may interpret the header information 600, and may determine whether the data is still image information or register information. The image receiving apparatus 200 may use the code for error detection to determine whether the received still image information has an error. That is, when a predetermined amount of still image information (for example, every line, every set of a predetermined number of lines, or every set of a predetermined number of pixels) is stored in the video data storage module 235, the image receiving apparatus 200 may perform error detection.

When still image information having been transmitted has an error, the image receiving apparatus 200 performs a process of changing the still image information (that is, which also serves as a process for addressing the error, in printing). For example, when it is determined that an error is present, still image information in the area, in which the error is present, (and its subsequent area) may be replaced. Specifically, in order to clarify the presence of an error (in order to notify a user of the presence of an error), an area, in which the error is present, may be changed so as to be emphasized. Alternatively, the change may be performed by dynamically switching among multiple change methods. Alternatively, in accordance with the image quality level (specifically, the frequency of occurrence of an error), a user may be notified of failure of proper printing.

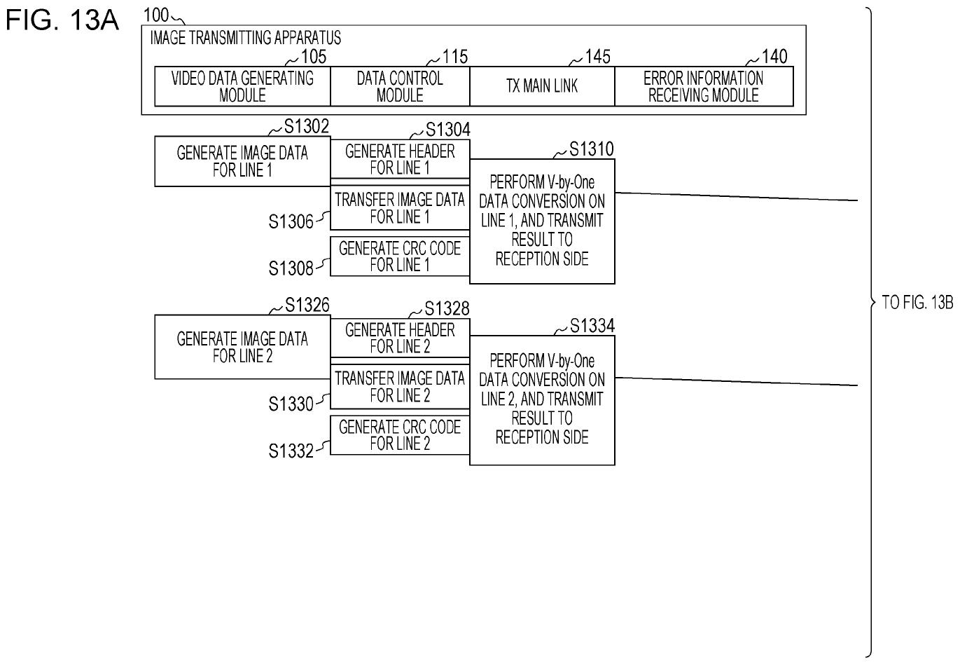

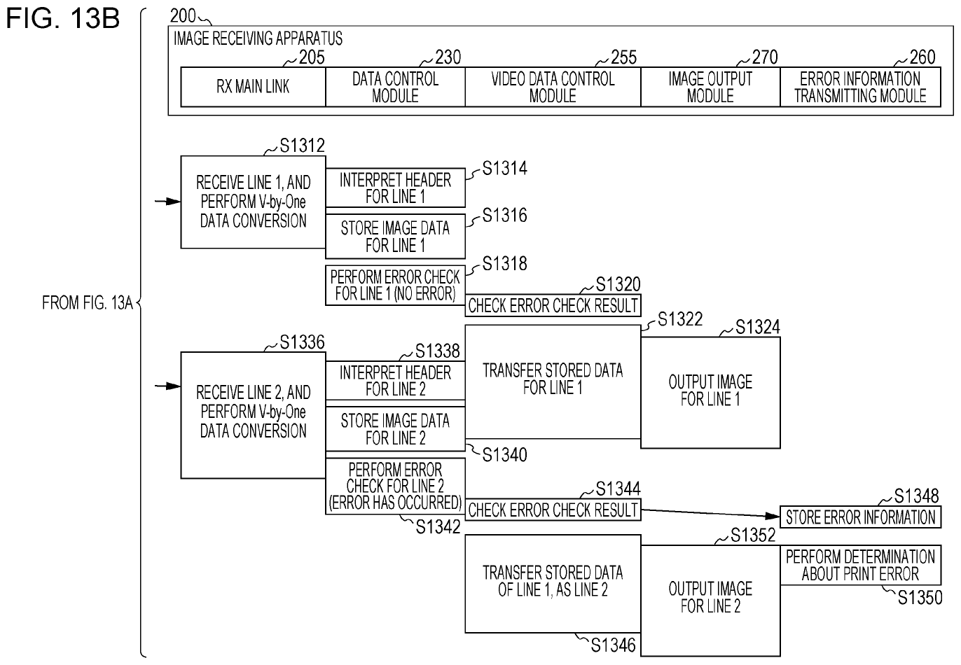

FIGS. 13A and 13B are a flowchart of an exemplary process according to the exemplary embodiment. The processes performed by the video data generating module 105, the data control module 115, the Tx main link 145, and the error information receiving module 140 of the image transmitting apparatus 100 and the Rx main link 205, the data control module 230, the video data control module 255, the image output module 270, and the error information transmitting module 260 of the image receiving apparatus 200 will be described. These modules perform so-called pipe-line processing.

In the example in FIGS. 13A and 13B, a line in which an error is present is replaced with the data of its previous line.

The example in FIGS. 13A and 13B illustrates a process of receiving/transmitting line 1 and line 2 of still image information. A similar process is performed for reception/transmission of the other lines.

In step S1302, the video data generating module 105 generates image data for line 1.

In step S1304, the data control module 115 generates the header for line 1.

In step S1306, the data control module 115 transfers the image data for line 1.

In step S1308, the data control module 115 generates a CRC code (an example of a code for error detection) for line 1.

In step S1310, the Tx main link 145 performs V-by-One data conversion on the data for line 1, and transmits the resulting data to the image receiving apparatus 200.

In step S1312, the Rx main link 205 receives the data for line 1, and performs V-by-One data conversion on the received data.

In step S1314, the data control module 230 interprets the header for line 1.

In step S1316, the data control module 230 stores the image data for line 1.

In step S1318, the data control module 230 performs error check for line 1. In this example, assume that no error is present.

In step S1320, the video data control module 255 checks the error check result.

In step S1322, the video data control module 255 transfers, to the image output module 270, the stored data for line 1.

In step S1324, the image output module 270 outputs the image for line 1.

In step S1326, the video data generating module 105 generates image data for line 2.

In step S1328, the data control module 115 generates the header for line 2.

In step S1330, the data control module 115 transfers the image data for line 2.

In step S1332, the data control module 115 generates a CRC code for line 2.

In step S1334, the Tx main link 145 performs V-by-One data conversion on the data for line 2, and transmits the resulting data to the image receiving apparatus 200.

In step S1336, the Rx main link 205 receives the data for line 2, and performs V-by-One data conversion on the received data.

In step S1338, the data control module 230 interprets the header for line 2.

In step S1340, the data control module 230 stores the image data for line 2.

In step S1342, the data control module 230 performs error check for line 2. In this example, assume that an error is present.

In step S1344, the video data control module 255 checks the error check result obtained by the data control module 230.

In step S1346, for line 2, the video data control module 255 transfers, to the image output module 270, the stored data for line 1.

In step S1348, the error information transmitting module 260 stores error information. The error information transmitting module 260 stores, as a log entry, information describing that an error has occurred in line 2.

In step S1350, the error information transmitting module 260 performs determination about whether or not a print error is present.

In step S1352, the image output module 270 outputs the image for line 2 (its information is the information of line 1).

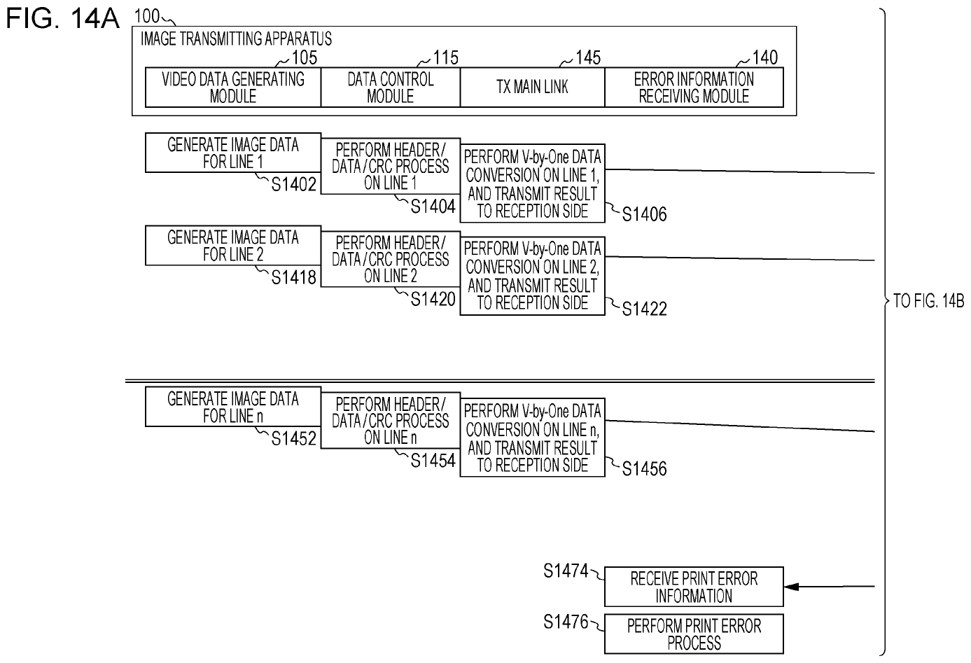

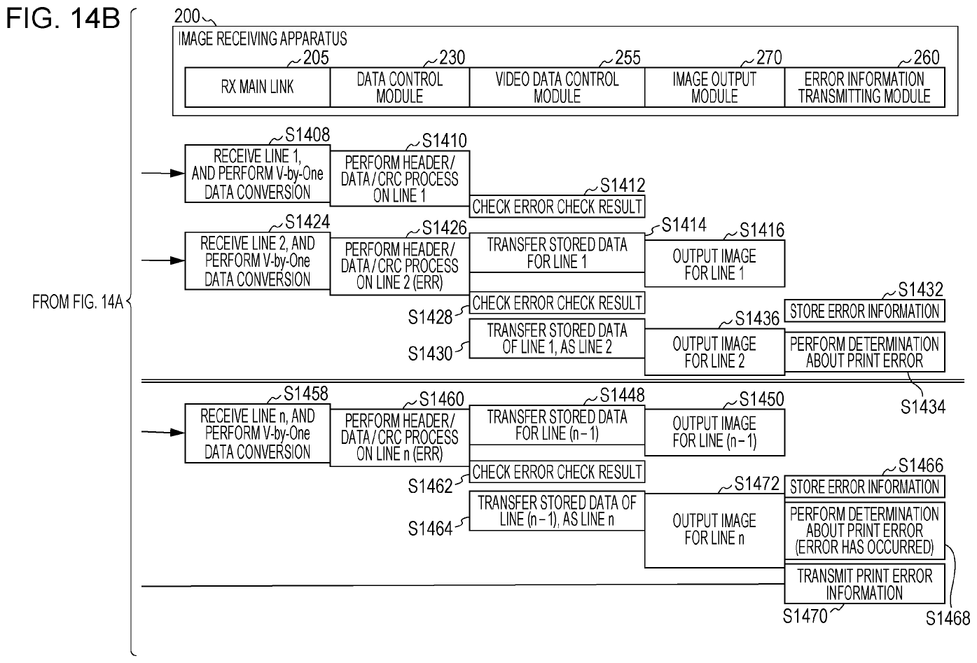

FIGS. 14A and 14B are a flowchart of an exemplary process according to the exemplary embodiment. The first half of the process (the processes until step S1436) is equivalent to the process illustrated in the example in FIGS. 13A and 13B.

In step S1402, the video data generating module 105 generates image data for line 1.

In step S1404, the data control module 115 performs the header/data/CRC process on line 1.

In step S1406, the Tx main link 145 performs V-by-One data conversion on the data for line 1, and transmits the resulting data to the image receiving apparatus 200.

In step S1408, the Rx main link 205 receives the data for line 1, and performs V-by-One data conversion on the received data.

In step S1410, the data control module 230 performs the header/data/CRC process on line 1. In this example, assume that no error is present.

In step S1412, the video data control module 255 checks the error check result.

In step S1414, the video data control module 255 transfers, to the image output module 270, the stored data for line 1.

In step S1416, the image output module 270 outputs the image for line 1.

In step S1418, the video data generating module 105 generates image data for line 2.

In step S1420, the data control module 115 performs the header/data/CRC process on line 2.

In step S1422, the Tx main link 145 performs V-by-One data conversion on the data for line 2, and transmits the resulting data to the image receiving apparatus 200.

In step S1424, the Rx main link 205 receives the data for line 2, and performs V-by-One data conversion on the received data.

In step S1426, the data control module 230 performs the header/data/CRC process on line 2. In this example, assume that an error is present.

In step S1428, the video data control module 255 checks the error check result.

In step S1430, for line 2, the video data control module 255 transfers, to the image output module 270, the stored data for line 1.

In step S1432, the error information transmitting module 260 stores error information.

In step S1434, the error information transmitting module 260 performs determination about whether or not a print error is present.

In step S1436, the image output module 270 outputs the image for line 2.

In step S1448, the video data control module 255 transfers, to the image output module 270, the stored data for line (n−1).

In step S1450, the image output module 270 outputs the image for line (n−1).

In step S1452, the video data generating module 105 generates image data for line n.

In step S1454, the data control module 115 performs the header/data/CRC process on line n.

In step S1456, the Tx main link 145 performs V-by-One data conversion on the data for line n, and transmits the resulting data to the image receiving apparatus 200.

In step S1458, the Rx main link 205 receives the data for line n, and performs V-by-One data conversion on the received data.

In step S1460, the data control module 230 performs the header/data/CRC process on line n. In this example, assume that an error is present.

In step S1462, the video data control module 255 checks the error check result.

In step S1464, for line n, the video data control module 255 transfers, to the image output module 270, the stored data for line (n−1).

In step S1466, the error information transmitting module 260 stores error information.

In step S1468, the error information transmitting module 260 performs determination about whether or not a print error is present. In this example, assume that an error is present.

In step S1470, the error information transmitting module 260 transmits the print error information.

In step S1472, the image output module 270 outputs the image for line n.

In step S1474, the error information receiving module 140 receives the print error information.

In step S1476, the error information receiving module 140 performs a print error process. For example, a message that an error has occurred may be displayed to a user.

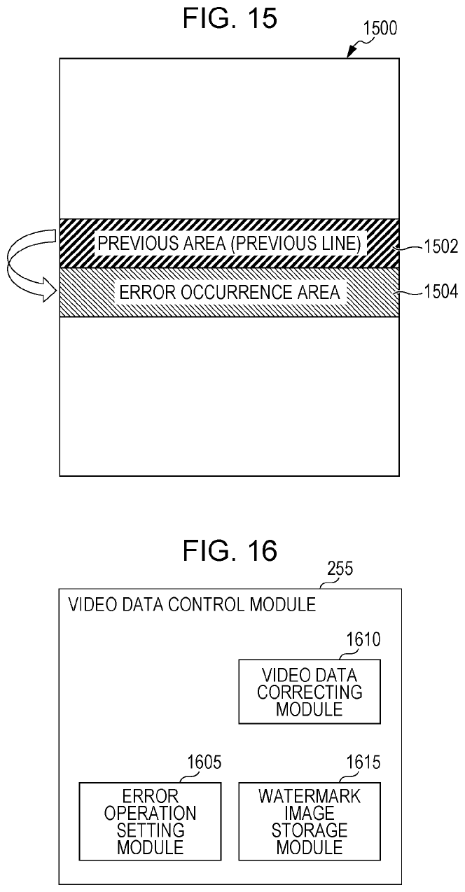

FIG. 15 is a diagram for describing an exemplary process according to the exemplary embodiment. The change process illustrated in the examples in FIGS. 13 and 14 is a process of replacing an error occurrence area 1504 in an image 1500 with a previous area (previous line) 1502, as illustrated in the example in FIG. 15.

Other than this, as change of information (rewriting data) in an error occurrence area, the following processes may be performed.

(1) Make the error data remain as it is

(2) Replace the data with blank data

(3) Replace the data with data indicating grey

(4) Replace the error line and its subsequent lines with blank data

FIG. 16 is a conceptual diagram illustrating an exemplary module configuration in the video data control module 255. Multiple change processes to be performed when an error occurs may be prepared, and one of the change processes may be selected.

To do this, the video data control module 255 includes an error operation setting module 1605, a video data correcting module 1610, and a watermark image storage module 1615.

The error operation setting module 1605 sets in advance a change process performed when still image information has an error. For example, in the case of a process of change to a predetermined color, for example, the color information and the number of lines to be replaced are set. In the case of a process of adding a watermark (an example of digital watermark information), for example, the number of lines, to which a watermark is added, is set.

The vide data correcting module 1610 changes the image information in an area, in which an error is present, according to the settings made by the error operation setting module 1605.

The watermark image storage module 1615 adds a watermark to an area in which an error is present.

The video data control module 255 obtains information indicating whether or not received still image information has an error, from the data control module 230 (error detecting module 240). When an error is present, the vide data correcting module 1610 or the watermark image storage module 1615 performs the process that is set by the error operation setting module 1605. For example, when the error operation setting module 1605 makes a setting for adding a watermark, the video data control module 255 adds a watermark image to the still image information of the line having an error and its subsequent lines, and transmits the resulting data to the image output module 270.

Examples of a change process which is set by the error operation setting module 1605 include the following.

(1) Examples of a process for making an error inconspicuous include the following.

(1-1) Make the error data remain as it is

(1-2) Replace the color of the data with a specified color

(1-3) Replace the error data with the data in the previous data

(2) Examples of a process for emphasizing an error include the following.

(2-1) Replace the color of the line having an error and its subsequent lines with a predetermined color (until the end of the page, or its subsequent lines whose number is predetermined)

(2-2) Add a watermark

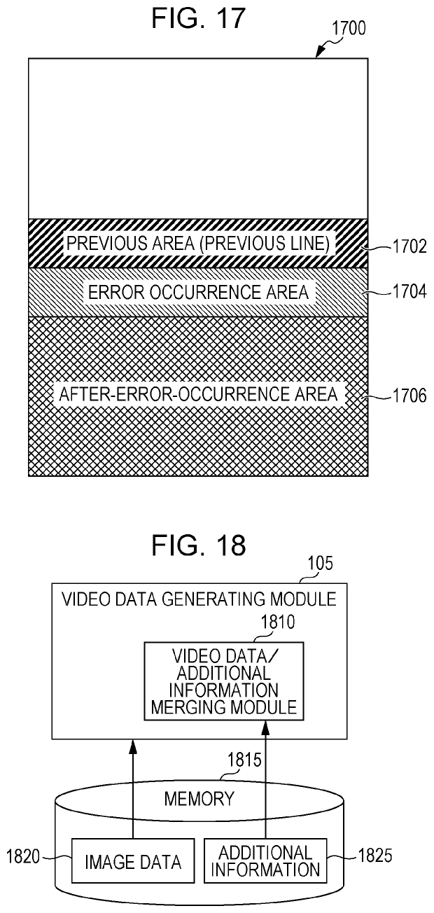

The example in FIG. 17 illustrates the relationship between an error occurrence area 1704 and a previous area (previous line) 1702, and between the error occurrence area 1704 and an after-error-occurrence area 1706 in an image 1700. That is, the previous area (previous line) 1702 is the immediately preceding adjacent line of the error occurrence area 1704. The after-error-occurrence area 1706 is an area starting from the line just after the error occurrence area 1704 (which may be the area until the end of the image 1700, or may correspond to a predetermined number of lines).

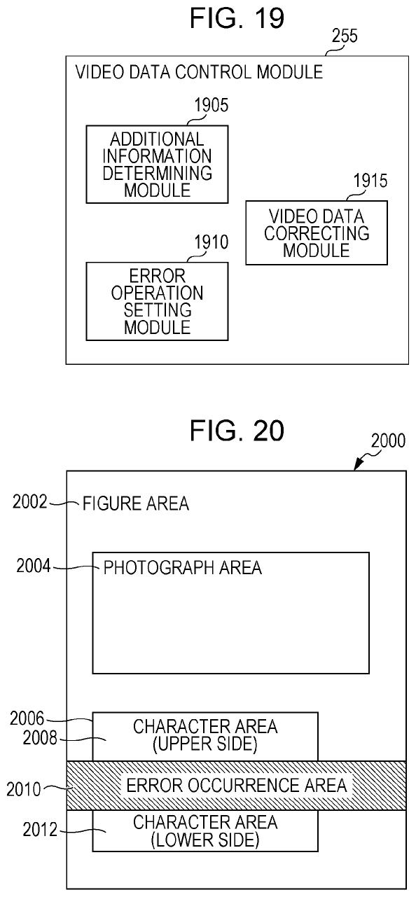

When an error for still image information is detected, the change operation on the still image information may be automatically switched. FIG. 18 illustrates an exemplary configuration in the image transmitting apparatus 100. FIG. 19 illustrates an exemplary configuration in the image receiving apparatus 200.

FIG. 18 is a conceptual diagram of an exemplary module configuration in the video data generating module 105 of the image transmitting apparatus 100.

The video data generating module 105 includes a video data/additional information merging module 1810. The video data generating module 105 has a configuration in which, when still image information has an error after transmission, additional information indicating how the still image information is to be changed may be transmitted.

The video data/additional information merging module 1810 has a function of reading, from a memory 1815, additional information 1825 prepared in advance for still image information, and merging (combining) image data 1820, which is still image information, with the additional information 1825. For example, a single piece of additional information 1825 may be added to each pixel of the image data 1820. Alternatively, a single piece of additional information 1825 may be added to each line of the image data 1820. Alternatively, a single piece of additional information 1825 may be added to each area of the image data 1820. To reduce the transmission amount of the additional information 1825, the transmission is desirably performed for each line or each area, not each pixel.

Examples of the additional information 1825 include the following: (1) photograph area; (2) figure area (graphics area); and (3) character area.

The data control module 115 exerts control so that the image data 1820 and the additional information 1825 which have been merged are transmitted to the image receiving apparatus 200 which is on the reception side.

The additional information 1825 is obtained by performing image processing (also referred to as a text/image (TI) separating process) for performing attribute determination in advance on still image information. The processing result is stored in the memory 1815. For example, a decomposer may be used to prepare the additional information 1825 in advance. Alternatively, as the character attribute described above, sub-attributes, such as an attribute indicating that a number is included and an attribute indicating that the font is small, may be added.

FIG. 19 is a conceptual diagram illustrating an exemplary module configuration in the video data control module 255 of the image receiving apparatus 200.

The video data control module 255 includes an additional information determining module 1905, an error operation setting module 1910, and a video data correcting module 1915.

The error operation setting module 1910 sets in advance a process which corresponds to each type of additional information and which is performed in the case where it is determined that an error is present. For example, change processes are set in accordance with the attribute as follows.

(1) Photograph area: replace error data with the data in the previous area

(2) Figure area: replace error data with bank image (data indicating a blank)

(3) Character area: use an error image as it is

When the data control module 230 (error detecting module 240) determines that still image information has an error, the additional information determining module 1905 determines which attribute the still image information has.

The vide data correcting module 1915 dynamically switches the change process to the process which has been set for the attribute of the still image information, performs the change process, and transmits the changed still image information to the image output module 270.

FIG. 20 is a diagram for describing an exemplary process according to the exemplary embodiment.

An image 2000 includes a figure area 2002, a photograph area 2004, and a character area 2006. Assume that an error occurrence area 2010 occurs. The character area 2006 is separated into a character area (upper side) 2008 and a character area (lower side) 2012 with the error occurrence area 2010 interposed in between.

When the attribute information is added to each pixel, a figure area portion in the error occurrence area 2010 is replaced with blank pixels, and a character area portion in the error occurrence area 2010 remains as it is (the data in the error occurrence area 2010 remains as it is).

When the attribute information is added to each line or each area, a change process according to the attribute of the line or the area may be performed.

In the case where, for a photograph area and a character area, blank pixels in the immediately preceding adjacent line of the line, in which it is found that an error is present, and the line previous to the immediately preceding adjacent line (two lines just before the error line) are counted, and where the ratio of the blank pixel count with respect to the pixel count in the two lines is equal to or greater than a predetermined ratio, a process of change to blank pixels may be performed.

In accordance with the print mode (such as the high image quality mode and the draft mode), a different change process may be performed. Whether the mode is the high image quality mode or the draft mode may be determined on the basis of the resolution of the video data control module 255. For example, in the case of 1200 dots per inch (DPI), it may be determined that the mode is the high image quality mode. In the case of 300 DPI, it may be determined that the mode is the draft mode. For example, when the print mode is the high image quality mode (when a slight error is allowed), a change process for making an error inconspicuous (such as replacing error data with the data in the previous area) may be performed. For example, when the print mode is the draft mode (when even a slight error is not allowed), a process for emphasizing an error (such as replacing error data with black pixels or adding a watermark) may be performed. In accordance with the user settings, an inverted change process may be performed. That is, a process for emphasizing an error may be performed when the print mode is the high image quality mode, and a change process for making an error inconspicuous may be performed when the print mode is the draft mode.

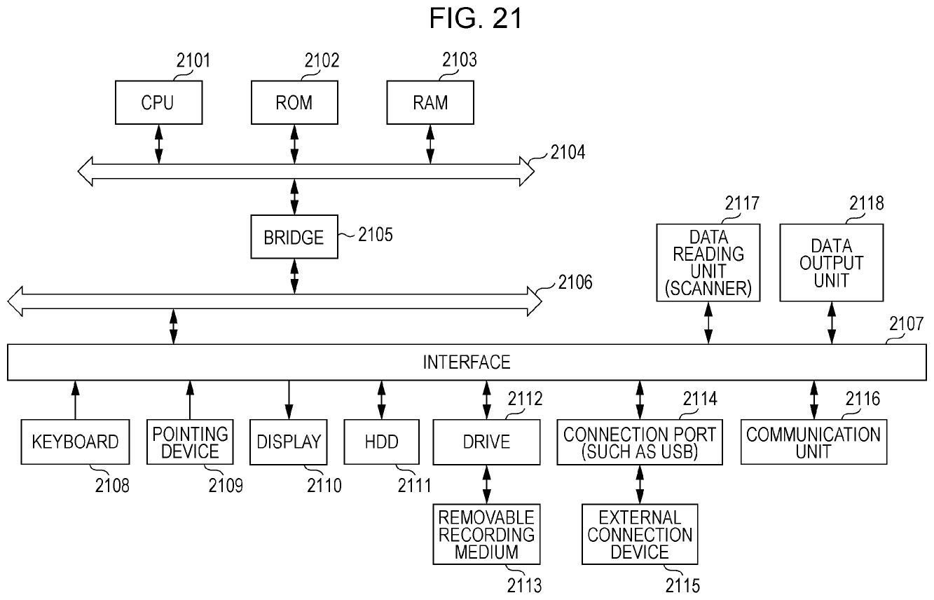

Referring to FIG. 21, an exemplary hardware configuration of the image transmitting apparatus 100 and the image receiving apparatus 200 according to the exemplary embodiment will be described. The configuration illustrated in FIG. 21 is constituted, for example, by a personal computer (PC), and an exemplary hardware configuration including a data reading unit 2117 such as a scanner and a data output unit 2118 such as a printer is illustrated.

A CPU 2101 is a controller performing processes according to computer programs describing execution sequences of the various modules described in the above-described exemplary embodiment, that is, the video data generating module 105, the data control module 115, the error-detecting-code generating module 120, the header generating module 125, the timing control module 130, the error-information-request receiving module 135, the error information receiving module 140, the data control module 230, the error detecting module 240, the header interpreting module 245, the register access control module 250, the video data control module 255, the error information transmitting module 260, the image output module 270, and the like.

A read only memory (ROM) 2102 stores programs, operation parameters, and the like which are used by the CPU 2101. A RAM 2103 stores programs used in execution performed by the CPU 2101, parameters changed as appropriate in the execution, and the like. These are connected to each other through a host bus 2104 constituted, for example, by a CPU bus.

The host bus 2104 is connected to an external bus 2106 such as a Peripheral Component Interconnect/Interface (PCI) bus via a bridge 2105.

A keyboard 2108 and a pointing device 2109 such as a mouse are devices operated by an operator. A display 2110 which is a liquid-crystal display apparatus, a cathode ray tube (CRT), or the like displays various types of information as text and image information. A touch screen or the like including both the functions of the pointing device 2109 and the display 2110 may be used. In this case, the function of the keyboard may be implemented in such a manner that, instead of physical connection as in the keyboard 2108, a keyboard (also referred to as a so-called software keyboard, a screen keyboard, or the like) is drawn by using software on a screen (touch screen).

A hard disk drive (HDD) 2111, which includes a hard disk (which may be a flash memory or the like), drives the hard disk, and records or reproduces information and programs executed by the CPU 2101. The HDD 2111 achieves the function of the video data storage module 235 or the like. Further, the HDD 2111 stores other various data, various computer programs, and the like.

A drive 2112 reads data or programs recorded in a removable recording medium 2113, such as a magnetic disk, an optical disk, a magneto-optical disk, or a semiconductor memory, which is mounted, and supplies the data or the programs to the RAM 2103 connected via an interface 2107, the external bus 2106, the bridge 2105, and the host bus 2104. The removable recording medium 2113 is also available as a data recording area.

A connection port 2114 which is a port for connecting an external connection device 2115 has a connection unit of USB, IEEE 1394, or the like. The connection port 2114 is connected to the CPU 2101 and the like via the interface 2107, the external bus 2106, the bridge 2105, the host bus 2104, and the like. A communication unit 2116 is connected to a communication line, and performs data communication with the outside. The data reading unit 2117, which is, for example, a scanner, reads documents. The data output unit 2118, which is, for example, a printer, outputs document data. The Tx main link 145 and the Rx main link 205 may be used as the connection port 2114 and the communication unit 2116.

For the exemplary embodiment achieved by using computer programs among the above-described exemplary embodiments, the computer programs which are software are read into a system having the hardware configuration, and the software and hardware resources cooperate with each other to achieve the above-described exemplary embodiment.

The hardware configuration of the image transmitting apparatus 100 and the image receiving apparatus 200 in FIG. 21 is merely one exemplary configuration. The exemplary embodiment is not limited to the configuration in FIG. 21, and may have any configuration as long as the modules described in the exemplary embodiment may be executed. For example, a subset of the modules may be constituted by dedicated hardware, such as an application specific integrated circuit (ASIC) or a field-programmable gate array (FPGA), and a subset of the modules may be installed in an external system connected through a communication line. In addition, systems having the configuration illustrated in FIG. 21 may be connected to one another through communication lines and may cooperate with one another. In particular, the hardware configuration may be installed in portable information communication equipment (including a portable phone, a smartphone, a mobile device, and a wearable computer), home information equipment, a robot, a copier, a fax, a scanner, a printer, a multi-function device (an image processing device having at least two of the functions of scanning, printing, copying, faxing, and the like), or the like as well as a personal computer.

The programs described above may be provided through a recording medium storing the programs, or may be provided through a communication unit. In these cases, for example, the programs described above may be interpreted as a disclosure of “a computer-readable recording medium that stores a program”.

The term “a computer-readable recording medium that stores a program” refers to a computer-readable recording medium that stores programs and that is used for, for example, installation and execution of the programs and distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray™ Disk, a magneto-optical disk (MO), a flexible disk (FD), a magnetic tape, a hard disk, a ROM, an electrically erasable programmable ROM (EEPROM™), a flash memory, a RAM, and a secure digital (SD) memory card.

For example, all or a subset of the above-described programs may be stored and distributed by recording them on the recording medium. In addition, the programs may be transmitted through communication, for example, by using a transmission medium of, for example, a wired network or a wireless communication network which is used for a local area network (LAN), a metropolitan area network (MAN), a wide area network (WAN), the Internet, an intranet, an extranet, and the like, or a combination of these. Alternatively, the programs may be carried on carrier waves.

The above-described programs may constitute a subset or all of other programs, or may be recorded on a recording medium along with other programs. Alternatively, the programs may be recorded on multiple recording media by dividing the programs. The programs may be recorded in any format, such as compression or encryption, as long as it is possible to restore the programs.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image transmitting apparatus comprising:
a transmitter that transmits information according to a standard for video image communication; and
a first processor that exerts control to determine whether transmission data is still image information or information other than still image information and to generate header information indicating that the transmission data is either the still image information or the information other than still image information,
wherein the transmitter transmits the still image information or the information other than still image information along with the corresponding header information by using a bus for video image communication in accordance with the control exerted by the first processor.

2. The image transmitting apparatus according to claim 1,
wherein the information other than still image information is register information that is to be stored in a register of an image receiving apparatus that is a transmission destination.

3. The image transmitting apparatus according to claim 2,
wherein the transmitter transmits the information for determining whether the transmission data is the register information or the still image information.

4. The image transmitting apparatus according to claim 3, wherein, in transmission of the register information, the first processor generates the header information indicating that the transmission data is the register information and exerts control in such a manner that the generated header information is transmitted.

5. The image transmitting apparatus according to claim 4, wherein the first processor further generates a code for error detection for information that is to be transmitted and exerts control in such a manner that the generated code is transmitted.

6. The image transmitting apparatus according to claim 5,
wherein, when information indicating that an error is present in register information is received from the transmission destination, the first processor exerts control in such a manner that at least the register information for which the error has occurred is transmitted to the transmission destination.

7. The image transmitting apparatus according to claim 6,
wherein, when the information indicating that an error is present is received from the transmission destination, the first processor exerts control in such a manner that a first operation or a second operation is performed, the first operation being an operation in which only the register information for which the error has occurred is transmitted to the transmission destination, the second operation being an operation in which register information which has already transmitted and which includes the register information for which the error has occurred is transmitted to the transmission destination.

8. An image receiving apparatus comprising:
a receiver that receives, according to a standard for video image communication, information from the image transmitting apparatus according to claim 5;
a second processor that detects an error for still image information by using a code for error detection, the code for error detection being included in the received information,
wherein when an error is detected for still image information, the second processor performs a change operation of changing the still image information into information indicating that the still image information has an error.

9. The image receiving apparatus according to claim 8,
wherein the second processor changes an error portion of the still image information in such a manner that the error portion is made inconspicuous or is emphasized, the error portion of the still image information being a portion in which the error is present.

10. The image receiving apparatus according to claim 9,
wherein, as the change operation for making the error portion inconspicuous, the second processor replaces the error portion of the still image information with data of a previous area.

11. The image receiving apparatus according to claim 9,
wherein, as the change operation for emphasizing the error portion, the second processor replaces the error portion of the still image information with image information of a predetermined color, or embeds information in the received still image information, the embedded information indicating that an error is present.

12. The image receiving apparatus according to claim 11,
wherein, as the information indicating that an error is present, digital watermark information is used.

13. The image receiving apparatus according to claim 8,
wherein the second processor makes the change operation different depending on an attribute of the received still image information.

14. The image receiving apparatus according to claim 13,
wherein, when the attribute indicates a photograph area, the second processor replaces the error portion of the still image information with data of a previous area.

15. The image receiving apparatus according to claim 13,
wherein, when the attribute indicates a figure area, the second processor replaces the error portion of the still image information with data indicating a blank.

16. The image receiving apparatus according to claim 13,
wherein, when the attribute indicates a character area, the second processor uses the error portion of the still image information as it is.

17. A non-transitory computer readable medium storing a program causing a computer to execute a process for image transmission, the process comprising:
transmitting information according to a standard for video image communication; and
exerting control to determine whether transmission data is still image information or information other than still image information and to generate header information indicating that the transmission data is either the still image information or the information other than still image information,
wherein the still image information or the information other than still image information is transmitted along with the corresponding header information by using a bus for video image communication in accordance with the control.

18. A non-transitory computer readable medium storing a program causing a computer to execute a process for image reception, the process comprising:
receiving, according to a standard for video image communication, information from the image transmitting apparatus according to claim 5;
detecting an error for still image information by using a code for error detection, the code for error detection being included in the received information; and
when an error is detected for still image information, performing a change operation of changing the still image information into information indicating that the still image information has an error.
